(19) United States
(12) Patent Application Publication
(10) Pub. No.: US 2008/0294627 A1
(43) Pub. Date: Nov. 27, 2008

(54) Board Recruiting

(75) Inventor: Daniel Wadsworth, New York, NY (US)

Correspondence Address: FISH & RICHARDSON PC, P.O. BOX 1022, MINNEAPOLIS, MN, 55440-1022, US

(73) Assignee: THE NASDAQ OMX GROUP, INC., Rockville, MD (US)

(21) Appl. No.: 12/108,207

(22) Filed: Apr. 23, 2008

Related U.S. Application Data
(60) Provisional application No. 61/000,296, filed on May 21, 2007.

(51) Int. Cl. G06F 7/10; G06F 17/30

(52) U.S. Cl. 707/5; 707/E17.017

(57) ABSTRACT

Methods, systems, and computer program products for recruiting candidates for a position on a board are described. In a computer system, a degree of matching between a profile of a candidate and a profile of the board is determined, and the candidate is introduced to the board after establishing a mutual interest between the candidate and the board based on the determined degree of match.

### CROSS-RELATED APPLICATION

Under 35 U.S.C. 119(e)(1), this application claims the benefit of provisional application Ser. No. 61/000,296, filed May 21, 2007.

### BACKGROUND

This invention relates to online recruiting.

Online recruiting sites help candidates to find employment opportunities and employers to find suitable candidates for employment positions. Most online recruitment sites are considered job boards. Job boards typically involve resume database search-based recruiting. On these sites, recruiters and employers post jobs and contact any candidate in the resume database.

Board recruiting involves seeking highly qualified candidates to serve on corporate and other legal entity governing boards. Some current methods for board recruiting often involve ad hoc approaches, such as referrals from friends and colleagues, and these approaches are often limited in the number and diversity of candidates that are obtained. Other conventional approaches for board recruiting include commissioning executive recruiting firms to find candidates for board positions.

### SUMMARY

As the demand for more diverse candidates with specific skill sets and personal qualities continues to grow, there exists a basic need for an organized and cost efficient approach to help boards and candidates find each other. This need becomes increasingly more apparent as regulations require deeper independence and the role becomes more intensive, and personal risk grows for those serving on boards. Set forth below is an online board recruiting system that attempts to fulfill the board recruiting needs of all types of companies and organizations (both public and private) and provides services that promote loyalty between board members.

The service collects profiles of both boards and candidates. The board profile includes a description of an opportunity for a position on the board. The description may include any insurance recommendations, compensation plans as well as a complete “talent gap analysis,” which describes the talents that are sought in a potential candidate and may be lacking among the current board members. The service allows boards and recruiters to search the candidate profiles and candidates to search opportunities posted by boards. Once a match has been made, the service provides mechanisms by which a board (or recruiter) can contact a candidate.

The invention provides systems and methods, including computer program products, for board recruiting.

In general, in one aspect, the invention features a computer-implemented method for recruiting candidates for a position on a board. The method includes determining in a computer system, a degree of matching between a profile of a candidate and a profile of the board, retrieved from a database of profiles of candidates and profiles of boards, the profile of the candidate including credentials of the candidate and the profile of the board including information about the position; and establishing a communication to introduce the candidate to the board after establishing a mutual interest between the candidate and the board based on the determined degree of match.

In general, in another aspect, the invention features a system for recruiting candidates for a position on a board. The system includes a database storing candidate profiles and board profiles, the candidate profiles including credentials of candidates interested in positions on boards and the board profiles including information about board member positions; and a server including one or more processors in electronic communication with the database. The one or more processors configured to determine a degree of matching between one of the candidate profiles and a board profile of a board seeking qualified candidates for an available position; and establishing a communication to introduce the candidate associated with the matching candidate profile to the board after establishing a mutual interest between the candidate and the board based on the determined degree of match.

In general, in a further aspect, the invention features a method that includes receiving a query from a user affiliated with the board, the query including criteria for sourcing qualified candidates for the position on the board; searching a database to determine candidate profiles that comply with the criteria of the query, the candidate profiles featuring candidates available for board member positions; enabling the user to access first sets of information associated with the candidate profiles acquired from the database; and deriving revenue from the board for completion of one or more activities involving the first set of information.

Embodiments may include one or more of the following. The method may further include accessing communication preferences included in the profile of the candidate and/or board, the communication preferences specifying how and by whom the candidate and/or board wishes to be contacted and limiting selected users from contacting the candidate and/or board; and establishing the communication in accordance with the communication preferences. An initial view of the matching candidate profile may be presented, where the initial view including a limited portion of information included in the candidate profile. Revenue may be derived in exchange for enabling the user to access second sets of information included in the candidate profiles, the second sets of information providing details that have been excluded from the initial views. Revenue may be derived by collecting a contingency fee after the board has appointed a candidate featured in one of the candidate profiles. Revenue may also be derived through other mechanisms, which are detailed further below.

The board recruiting service provides one or more of the following advantages among others. The service provides a cost effective and efficient approach to source qualified candidates willing and interested to serve on a board. Because the service is specifically designed to make introductions on the basis of mutual interest, conversations between boards and potential candidates are meaningful from the start. The service employs a flexible fee schedule that enables users to manage the costs of using the service. As a result, the fees incurred by using the service for appointing new directors are often far less than the fees for using an executive search firm. Because boards and candidates can set specific communication preferences, each party can control the conditions under which the party is contacted. Due to new regulations, boards have begun enforcing new term limits, the number of boards that directors can serve on at one time, and retirement age. Since the board recruiting service captures detailed candidate data, boards can conduct succession planning with relative ease and identify suitable replacements in advance.

The board recruiting service lowers costs associated with services provided by executive recruiting search firms by enabling the board itself to handle at least some of the candidate sourcing, pre-screening, assessment benchmarking, and other recruiting functions. Furthermore, the board recruiting service connects boards with candidates who may not have previously served on a board, but yet who have the appropriate qualifications, credentials, and experience to be a board member. Thus, the board recruiting service can provide a broader pool of candidates than that obtained using word of mouth referrals and other ad hoc methods.

The details of one or more embodiments of the invention are set forth in the accompanying drawings and the description below. Other features, objects, and advantages will be apparent from the description and drawings, and from the claims.

### DESCRIPTION OF DRAWINGS

FIG. 1 is a block diagram of a board recruiting system.

FIG. 2 is a flowchart of a board recruiting process implemented by the system of FIG. 1.

FIGS. 3A-3B are a block diagram of a database for use with the system of FIG. 1.

### DETAILED DESCRIPTION

Described is a board recruiting service that enables boards to find candidates for board member positions and potential candidates, e.g., Directors of Boards, to make themselves available to boards seeking new members. The board member positions posted by boards represent seats on boards and not jobs. Board seats are different than jobs in that they typically require a majority vote of the existing board members via the recommendation of a nominating committee and the selection process for a board position is not reported in the same way to the EEOC (Equal Opportunity Commission) as that of a typical job. Furthermore, unlike most jobs, board positions are not typically filled by hiring managers or human resources as they would in operational recruiting.

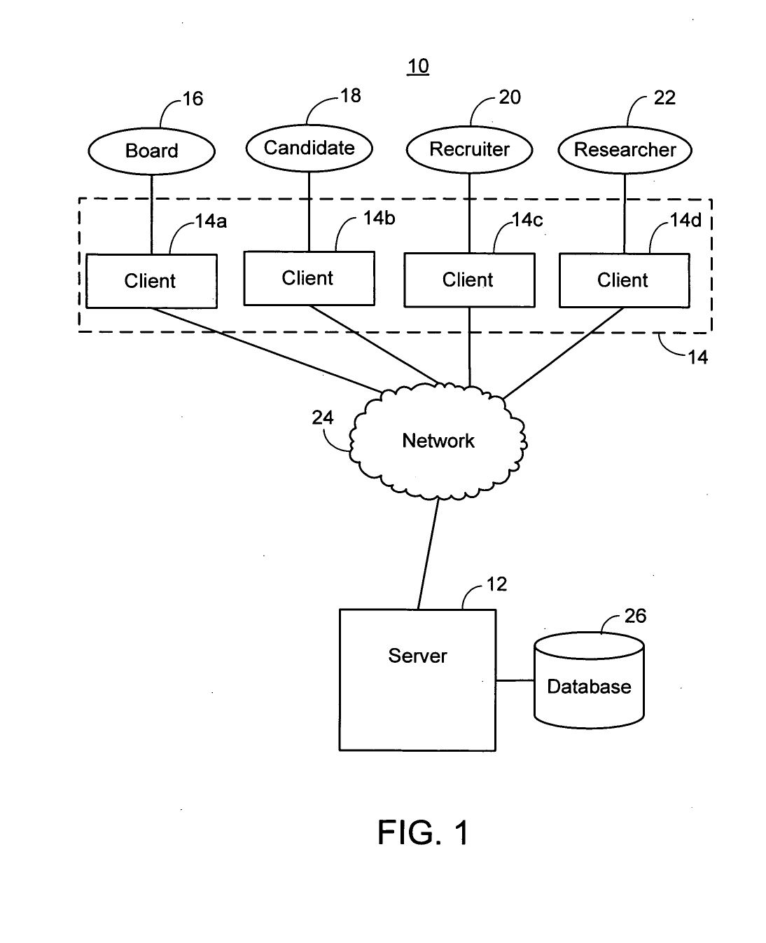

Referring to FIG. 1, a board recruiting system 10 includes a server 12 coupled to clients 14a-14d (collectively referred to as “clients 14”) via a network 24 (e.g., a LAN, WAN, the Internet, or a combination thereof), and a database 26 coupled to the server 12. Although the database 26 is shown to be external to the server 12, the database could be internal to the server 12 and could include multiple databases. The database 26 stores information provided by boards (e.g., board profiles, account info, etc.) and information provided by candidates (e.g., resumes, account info, etc.). The functions of the server 12 and database 26 are collectively referred to as a “board recruiting service.” The server 12 controls and facilitates the exchange of information stored in the database 26 between users of the board recruiting service.

Users include boards, candidates, recruiters, and researchers. A board 16, a candidate 18, a recruiter 20, and a researcher 22 access the server 12 using the client computer systems 14a-14d, respectively. The board 16 is any governing body of a company, e.g., a legal entity including, a corporation for instance, which by statute or other mechanism require a board of directors to independently oversee the management of the entity and safeguard investor interest. Such entities can include a public company, a private company, non-profit organizations, etc. The candidate 18 is any person who is interested in serving on a board, for example, a director of a company. The candidate 18 may or may not have previously served on a board. The recruiter 20 acts on behalf of a company to locate qualified candidates for a position on the company's board. The researcher 22 is typically a third party that accesses information from the server 12 primarily for research purposes. Both the recruiter 20 and the researcher 22 have limited access to the server 12 and may each be an individual, a group of individuals, a company, or an organization.

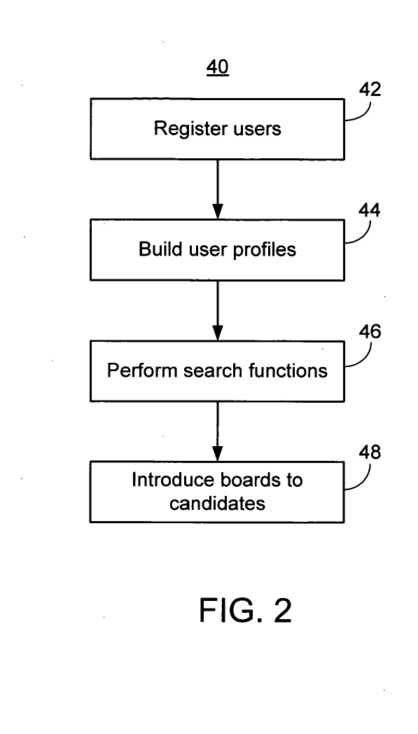

Referring to FIG. 2, a board recruiting process 40 is performed by the board recruiting system 10. The process 40 begins by registering (42) users to use the system 10. During registration (42), the process 40 solicits information from a user, such as identification information, and any upfront fees and generates an account for the user. The process 40 may also present legal contracts and/or agreements, such as “terms of use” agreements, to which the users may be required to consent in order to register with the service. The process 40 generates different types of accounts depending on the type of the user registering for the service (e.g., whether the user is a board 16, a candidate 18, a recruiter 20, or a researcher 22). Different types of accounts generally have different registration requirements (e.g., fees) and different information access privileges.

In some embodiments, a board 16 may be required to pay a general subscription fee to be granted access to all site content available to boards, though the service may provide the board 16 a short trial period during which no sign-up fee is be paid. A candidate 18 registers with the service by submitting required information (e.g., name and contact info) and paying a fee (e.g., one-time or annual) to post a candidate profile and to have his/her resume included in the database 26. Once registered, a candidate 18 obtains access to site content available to candidates. When registering, a recruiter 22 is asked to verify that the company being represented indeed has open positions that it is actively trying to fill. If a recruiter 22 does not have a live opportunity, its access to the service and site content may be restricted. A researcher 22 registers with the service by purchasing a general content subscription. An account assigned to a researcher 22 provides access to generic information about candidates (e.g., demographic information, etc.) but restricts access to information specific to candidates. For example, a researcher 22 may not be permitted access to candidate resumes. In some implementations, the service enables a researcher 22 to request contact with candidates (e.g., for research interviews, networking, etc.). This request is typically handled by the system. In response to the request, the system, acting as an intermediary, sends a message to a candidate. The candidate can accept the request, which is sent back to the system or alternatively the candidate can elect not to reply back.

After the process 40 registers (42) a user, the process 40 builds (44) a profile for the user based on information solicited from the user. User profiles include board profiles, candidate profiles, and recruiter profiles. A board profile features information about the board, such as a board prospectus, which includes the company name and a description of the company, a purpose statement, an agenda and schedule of board meetings, and the composition and structure of the board. The board profile also includes information about the board opportunity, including individual responsibilities and compensation. The board profile may further include qualifications and credentials that the board 16 seeks in a qualified candidate. The profile building process (44) solicits some of the information for the board profile by presenting the board 16 with survey questions that are tailored to drive market research.

The profile building process (44) solicits information from candidates by presenting the candidates with a questionnaire and an area for uploading resumes. A candidate profile includes information about a candidate 18 such as business and board experience, skills, education, certifications, and a resume. The candidate profile also includes characteristics of boards (e.g., market cap size, industry focus, company location, etc.) that are preferred by the candidate 18 and communication preferences that specify how and by whom the candidate 18 wishes to be contacted.

The communication preferences can be set to limit or prevent boards (or recruiters) from contacting candidates without their permission. For example, a candidate 18 may set the communication preference to allow only those boards that meet a given set of requirements (e.g., those that offer certain market cap sizes, industries, locations, or compensation plans) to contact the candidate 18. The candidate 18 can also set the communication preferences to limit who is allowed to view his/her information, thus his/her user profile can be maintained in complete confidentiality. Similarly, board profiles and recruiter profiles may also include communication preferences to limit and control contact from candidates 18.

The profile building process (44) solicits information from a recruiter 22 regarding the position for which the recruiter 22 is attempting to fill. The recruiter 22 profile includes characteristics of the board such as the market cap size of the company, industry focus, company location, board demographics, etc. In some embodiments, the process 44 does not require the recruiter to provide the name of the company or other specific information that would reveal the identity of the company.

After the user profiles have been built (44), the process 40 performs (46) search functions, e.g., using a search engine implemented by the server 12, that enable boards and recruiters to search for candidates and that enable candidates to search for positions on boards. A user enters a query for user profiles that comply with a set of search criteria selected by the user. Examples of search criteria that a board 16 may enter to source candidates include board experience, business experience, skills, certifications, education, and location. After receiving the query, the process 40 searches the database 26 for candidate profiles that match the criteria included in the query and return “initial views” of any matching profiles. An initial view presents a limited portion of information included in a corresponding candidate profile. The information provided in an initial view may include general information about the candidate's qualifications or position preferences without divulging the candidate's identity or contact information.

After an initial set of results are returned by the search functions, the user can modify the criteria of his/her initial query and submit a new query. In response to receiving the new query, the search engine searches the entire database for user profiles that comply with the new query. Even if the new query includes additional criteria that would only narrow the initially returned results, the search engine considers all of the profiles included in the database, rather than just the profiles that were originally returned.

For example, if a candidate wishes to narrow an initial set of search results showing boards of companies located in the Northeast region of the USA to include only those located in Massachusetts, the search functions would perform an entirely new search that considers all of the board profiles stored in the database, rather than those companies that were found in the initial set of search results. In other words, the results from a previous search are not carried over to a subsequent search even if the criteria of the subsequent search is strictly a subset of the criteria applied in the previous search

When presented with an initial view of user profiles returned by the search engine, a board 16 or recruiter 20 makes a determination about whether they want to request a full view of the candidate profile, which includes all of the details available for view in the candidate profile. A further fee may be required for a board 16 or recruiter 20 to obtain a full view of the candidate profile. Some details of the candidate profile (e.g., contact information) may not be shown in a full view. For example, the search process (46) intentionally excludes candidate resumes from the board's initial search criteria and from the initial matching results as it is often the case that resumes contain contact information, while the information on the resume overlaps much of the profile information that has already been captured by the system 10 and presented during the board search.

After considering information shown in a full view of a candidate profile, the board 16 may decide to contact the candidate featured in the profile. Similarly, after considering information shown in a board profile, an interested candidate 18 may request to contact the board 16 for further consideration. Thus, the service operates a profile matching system that matches board profiles to candidate profiles (and vice versa) rather than a job board that matches resumes to job postings and vice versa.

After a match has been determined, the process 40 introduces (48) the board 16 and the candidate 18 on the basis of mutual interest. That is, if both the board 16 and the candidate 18 express mutual interest in each other, the service puts them in direct contact with each other. For example, after a board 16 expresses an interest in contacting a particular candidate 18, the introduction process (48) first contacts the candidate 18 to determine whether the candidate 18 is interested in being contacted by the board 16. If the candidate 18 is interested, the process (48) follows the procedures specified in the communication preferences of the candidate's profile. Similarly, after a candidate 18 expresses an interest in a position offered by a board 16, the introduction process (48) contacts the board 16 to determine whether the board 16 is interested in the candidate 18. If the board 16 is interested, the process (48) follows the procedures specified in the communication preferences of the board's profile. In this manner, the introduction between the board 16 and the candidate 18 is made on the basis of mutual interest, and therefore, the subsequent conversations between boards and potential candidates are meaningful from the start.

The service also offers several candidate pre-screening assessment tools through third parties. These tools are provided to help boards source, identify and narrow a potential pool of candidates through: video interview assessments, personality and behavioral assessments, and learning style, leadership and communication assessments.

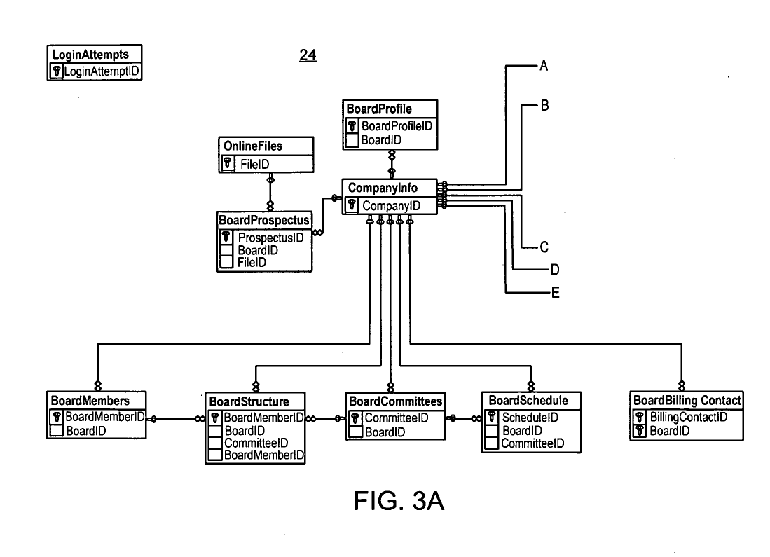

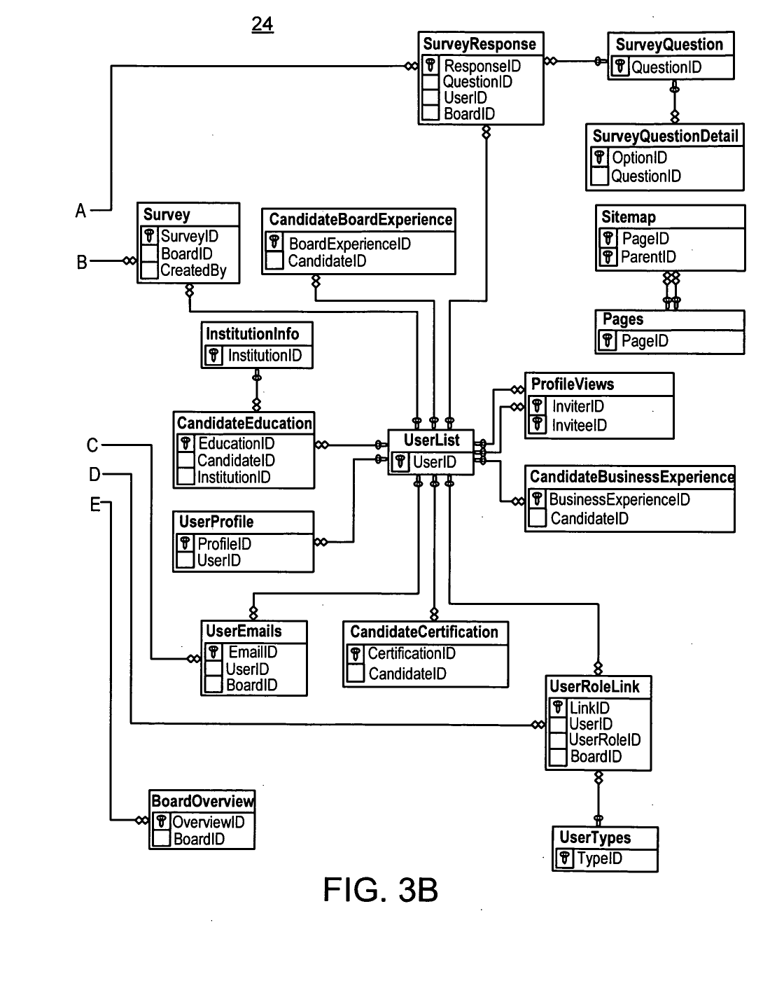

Referring to FIGS. 3A-3B, the content and organization of the database 26 are shown. Database information is organized into tables, which are shown as linked blocks. The tables are linked together according to relationships between the information stored in the tables.

The board recruiting service may employ a variety of revenue models and fee schedules. In some revenue models, candidates and board are allowed to use the service for an initial trial period before being charged a fee to register with the service. That is, the service offers candidates and boards the opportunity to post their profiles free of charge, for a limited period of time. After the time expires, candidates are charged a nominal fee for posting a profile. This fee is meant to act as a deterrent to any casual and/or unqualified user who may attempt to register with the service.

Boards pay an access fee and a flat rate contingency fee for each candidate successfully appointed as a board member through the service. As described above, boards pay a “view” fee for requesting a full view of a candidate profile after an initial view is presented. In some embodiments, the service implements a tiered pricing structure in which boards have the option to pay “per view,” to purchase a “view package” that grants a predefined number of views (e.g., 50 views) within a predetermined time period (e.g., a year), or to pay for unlimited views within a predetermined time period.

Contingency search fees may be assessed only when a candidate is appointed to a board as a direct result of being introduced through the board recruiting service. Furthermore, a “view” fee may be charged only after a board and a candidate have made initial contact (e.g., via email) and have subsequently agreed, through mutual interest, to release contact details to each other. Boards may be subjected to contingency search fees for a predetermined time period (e.g., twelve months) following the “view” package expiration date. Contingency search fees may be assessed to boards and not recruiters, who, for example, may be assessed higher “view” package fees at the time of registration.

Other fees may also be involved with the board recruiting service. For example, planned packaged services (e.g., third party candidate assessment tools, executive compensation reports, and the like) may be offered for an additional fee on a la carte basis.

The board recruiting service may require users to sign legal contracts to sway them against making or accepting “backdoor” offers that are made outside of the parameters of the service in an effort to avoid the contingency fee after the details of a potential board member are culled through the service. When it has been determined that a company has made or attempted to make a backdoor offer, the service may dismiss the company immediately from the service, apply the contingency fee anyway and retain whatever other rights it may have at law or equity. Similarly, candidates that accept or attempt to accept backdoor offers may have their account deleted and banned from using the service indefinitely.

Board Recruiting can be implemented as a web site, e.g., portal to connect and network potential Directors with Boards opportunities across all exchanges and private firms. Board recruiting is a valued added tool and service to help board members manage their workflow.

Some advantages provided by the system include easing the burden of nominating committees within boards, which have central responsibility for evaluating board member candidates While, today board members' personal contacts are the main resource for new board member recruiting, followed by CEO contacts and executive search firms, identifying qualified candidates is the biggest challenge for board member searches and quite expensive if sourced through Executive Search Firms. The system eases this burden by having the recruiting process be based upon mutual interest. Certain skills are important in board recruiting including expertise in finance. The difficulty of recruiting for specific skills and personal qualities as well as identifying diverse board candidates makes this type of search as relatively difficult. These difficulties are greatly ameliorated by an approach based on mutual interest.

A number of embodiments of the invention have been described. Nevertheless, it will be understood that various modifications may be made without departing from the spirit and scope of the invention. For instance, the profile based mutual interest approach could be adopted to improve the convention job searching approaches to find better matches between employers and candidates. The foregoing are examples for illustration only and not to limit the alternatives in any way.

The computer processes described herein can be implemented in digital electronic circuitry, or in computer software, firmware, or hardware, including the structural means disclosed in this specification and structural equivalents thereof, or in combinations of them. The processes can be implemented as one or more computer program products, i.e., one or more computer programs tangibly embodied in an information carrier, e.g., in a machine readable storage device or in a propagated signal, for execution by, or to control the operation of, data processing apparatus, e.g., a programmable processor, a computer, or multiple computers. A computer program (also known as a program, software, software application, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub-programs, or portions of code). A computer program can be deployed to be executed on one computer or on multiple computers at one site or distributed across multiple sites and interconnected by a communication network.

The processes described herein, including method steps, can be performed by one or more programmable processors executing one or more computer programs to perform functions of the processes by operating on input data and generating output. The processes can also be performed by, and apparatus of the processes can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Computer-readable media suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The processes can be implemented in a computing system that includes a back end component (e.g., a data server), a middleware component (e.g., an application server), or a front end component (e.g., a client computer having a graphical user interface or a Web browser through which a user can interact with an implementation of the processes), or any combination of such back end, middleware, and front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

The process 40 may be performed in orderings other than those shown in corresponding FIG. 2. Additionally, some of the steps may be performed at the same time, eliminated, or repeated. Elements of different embodiments described herein may be combined to form other embodiments not specifically set forth above. Accordingly, other embodiments are within the scope of the following claims.

What is claimed is:

1. A computer-implemented method for recruiting candidates for a position on a board, the method comprising:
determining in a computer system, a degree of matching between a profile of a candidate and a profile of the board, retrieved from a database of profiles of candidates and profiles of boards, the profile of the candidate including credentials of the candidate and the profile of the board including information about the position; and
establishing a communication to introduce the candidate to the board after establishing a mutual interest between the candidate and the board based on the determined degree of match.

2. The method of claim 1, wherein establishing a communication, further comprises:
accessing communication preferences included in the profile of the candidate, the communication preferences specifying how and by whom the candidate wishes to be contacted and limiting selected boards from contacting the candidate; and
establishing the communication in accordance with the communication preferences.

3. The method of claim 1, wherein establishing a communication, further comprises:
accessing communication preferences included in the profile of the board, the communication preferences limiting candidates' access to information contained in the profile of the board; and
establishing the communication in accordance with the communication preferences.

4. The method of claim 1, further comprising:
receiving a query submitted by a user affiliated with the board, the query including criteria for qualified candidates for the position on the board, the criteria included in the board profile; and wherein determining further comprises:
searching the database for candidate profiles; and
determining whether information included in the candidate profiles at least partially satisfy the criteria of the query.

5. The method of claim 1, further comprising presenting an initial view of the matching candidate profile, the initial view including a limited portion of information included in the candidate profile.

6. The method of claim 5, further comprising presenting additional portions of the information included in the candidate profile in response to receiving payment from the board, the additional portions including contact information of the candidate.

7. A system for recruiting candidates for a position on a board, the system comprising:
a database storing candidate profiles and board profiles, the candidate profiles including credentials of candidates interested in positions on boards and the board profiles including information about board member positions; and
a server including one or more processors in electronic communication with the database, the one or more processors configured to:
determine a degree of matching between one of the candidate profiles and a board profile of a board seeking qualified candidates for an available position; and
establishing a communication to introduce the candidate associated with the matching candidate profile to the board after establishing a mutual interest between the candidate and the board based on the determined degree of match.

8. The system of claim 7, wherein the one or more processors are further configured to establish the communication in accordance with communication preferences included in the candidate profiles, the communication preferences specifying how and by whom the candidates wish to be contacted by boards and limiting selected boards from contacting the candidates.

9. The system of claim 7, wherein the one or more processors are further configured to establish the communication in accordance with communication preferences included in the board profiles, the communication preferences limiting candidates' access to information contained in the board profiles.

10. The system of claim 7, wherein the one or more processors are further configured to:
receive a query submitted by a user affiliated with the board, the query including criteria for qualified candidates for the position on the board, the criteria included in the board profile;
search the database for candidate profiles; and
determine whether information included in the candidate profiles at least partially satisfy the criteria of the query.

11. The system of claim 7, wherein the one or more processors are further configured to present an initial view of the matching candidate profile, the initial view including a limited portion of information included in the candidate profile.

12. The system of claim 11, wherein the one or more processors are further configured to presenting additional portions of the information included in the candidate profile in response to receiving payment from the board, the additional portions including contact information of the candidate.

13. A computer program product for recruiting candidates for a position on a board, the computer program product being tangibly stored on machine readable media, comprising instructions operable to cause one or more processors to:
search a database storing profiles of candidates;
determine a degree of matching between a profile of a candidate and a profile of the board, the profile of the candidate including credentials of the candidate and the profile of the board including information about the position; and
establish a communication to introduce the candidate to the board after establishing a mutual interest between the candidate and the board based on the determined degree of match.

14. The product of claim 13, wherein the one or more processors are further configured to establish the communication in accordance with communication preferences included in the profile of the candidate, the communication preferences specifying how and by whom the candidate wishes to be contacted and limiting selected boards from contacting the candidate.

15. The product of claim 13, wherein the one or more processors are further configured to establish the communication in accordance with communication preferences included in the profile of the board, the communication preferences limiting candidates' access to information contained in the profile of the board.

16. The product of claim 13, wherein the one or more processors are further configured to:
receive a query submitted by a user affiliated with the board, the query including criteria for qualified candidates for the position on the board, the criteria included in the board profile;
search the database for profiles of candidates that at least partially satisfy the criteria of the query.

17. The product of claim 13, wherein the one or more processors are further configured to present an initial view of the matching candidate profile, the initial view including a limited portion of information included in the candidate profile.

18. The product of claim 17, wherein the one or more processors are further configured to present additional portions of the information included in the candidate profile in response to receiving confirmation of a payment submitted by the board, the additional portions including contact information of the candidate.

19. A computer-implemented method for recruiting candidates for a position on a board, the method comprising:
receiving a query from a user affiliated with the board, the query including criteria for sourcing qualified candidates for the position on the board;
searching a database to determine candidate profiles that comply with the criteria of the query, the candidate profiles featuring candidates available for board member positions;
enabling the user to access first sets of information associated with the candidate profiles acquired from the database; and
deriving revenue from the board for completion of one or more activities involving the first set of information.

20. The method of claim 19, wherein deriving revenue comprises:
receiving a registration fee from the board in exchange for enabling the user to submit the query to the server.

21. The method of claim 19, wherein deriving revenue comprises compensating the provider of the server in exchange for enabling the user to access second sets of information included in the candidate profiles, the second sets of information providing details that have been excluded from the first sets of information.

22. The method of claim 21, wherein compensating comprises collecting a package fee that grants users affiliated with the board a predefined number of accesses to the second sets of information included in the candidate profiles.

23. The method of claim 21, wherein compensating comprises collecting a package fee that grants users affiliated with the board with an unlimited number of accesses to the second sets of information included in the candidate profiles for a predetermined period of time.

24. The method of claim 21, wherein compensating occurs only after the board and a candidate featured in one of the candidate profiles have made initial contact and have agreed, through mutual interest, to release contact details to each other.

25. The method of claim 19, wherein deriving revenue comprises collecting a contingency fee after the board has appointed a candidate featured in one of the candidate profiles.
